(19) United States
(12) Patent Application Publication
(10) Pub. No.: US 2005/0126136 A1
(43) Pub. Date: Jun. 16, 2005

(54) Device for fixing a dust-collecting bag on a dust-collecting machine

(75) Inventor: Chieh Yuan Cheng, Taichung (TW)

Correspondence Address: TROXELL LAW OFFICE PLLC, 5205 LEESBURG PIKE, SUITE 1404, FALLS CHURCH, VA, 22041, US

(73) Assignee: San Ford Machinery Co., Ltd.

(21) Appl. No.: 10/731,470

(22) Filed: Dec. 10, 2003

(51) Int. Cl. B01D 46/02

(52) U.S. Cl. 55/341.2; 55/378; 55/508

(57) ABSTRACT

A device for fixing a dust-collecting bag on a dust-collecting machine includes a wind-exhausting box having an annular fit base formed with a curved engage surface shrinking inward at the upper inner wall, and a dust-collecting bag having its opening portion wrapped therein with a flexible tightening ring. After slightly pressed inward and deformed, the opening portion of the dust-collecting bag is received in the annular fit base and the dust-collecting bag is pulled outward to make the tightening ring inside the opening portion firmly stuck on the curved engage surface by its expanding resilience. After the tightening ring is disengaged from the engage surface in the wind-exhausting vent, the dust-collecting bag can be removed from the wind-exhausting box, quick and easy in assembling with and disassembling from the annular fit base.

### BACKGROUND OF THE INVENTION

1. Field of the Invention

This invention relates to a device for fixing a dust collecting bag on a dust-collecting machine, particularly to one having a simple structure and able to assemble a dust collecting bag on or disassemble it from a dust-collecting machine quickly.

2. Description of the Prior Art

A conventional dust-collecting machine 10, as shown in FIG. 1, includes a wind-exhausting box 11 having a wind-exhausting vent 111 in its topside for fitting a dust-collecting bag 12 thereon and a fan motor 13 connected with the wind-exhausting box 11. Thus, when the fan motor 13 operates, dust can be sucked into the dust-collecting bag 12 through the wind-exhausting box 11. The dust-collecting bag 12 is fitted around the outer circumferential edge of the exhausting opening 111 of the wind-exhausting box 11 and has its opening portion 121 firmly secured thereon by means of a clasping strap 14 so as to fix the dust-collecting bag 12 on the wind-exhausting box 11.

However, the way of assembling the dust-collecting bag 12 on the wind-exhausting box 11 by the clasping strap 14 has some drawbacks described below.

1. The clasping strap 14 is composed of a strap body 141, two clasps 142 respectively secured at the opposite ends of the strap 141 and a pull-press member 143 provided at the end of the clasp 142, having too many components, complicating structure and increasing cost.

2. The components of the clasping strap 14 are buckled with one another to be pulled and pressed; therefore these components are most likely to become loose and damaged after long term of use. Under the circumstances, the opening portion 121 of the dust-collecting bag 12 can hardly be secured firmly on the outer circumferential edge of the wind-exhausting vent 111 of the wind-exhausting box 11, easy to cause leakage of air and dust.

3. To assemble the dust-collecting bag 12 on the wind-exhausting box 11, firstly, the opening portion 121 of the dust-collecting bag 12 has to be fitted around the outer circumferential edge of the wind-exhausting vent 111 of the wind-exhausting box 11. Subsequently, the two clasps 142 at the opposite ends of the strap 141 are buckled with each other and then the pull-press member 143 is pressed inward to fix the strap 141 in place to finish assembly of the dust-collecting bag 12. On the contrary, to disassemble the dust-collecting bag 12 from the wind-exhausting box 11, the clasps 142 of the strap 141 have to be unbuckled and the pull-press member 143 has to be released to finish disassembling of the dust-collecting bag 12, complicated in operation.

### SUMMARY OF THE INVENTION

A first objective of the invention is to offer a device for securing a dust-collecting bag on a dust-collecting machine, able to quickly and directly assemble a dust-collecting bag on a wind-exhausting box without help of any additional tightening component and firmly fix the dust-collecting bag on the wind-exhausting box by increase of a vacuum sucking force and also able to remove the dust-collecting bag from the wind-exhausting box with ease and with less force.

A second objective of the invention is to offer a device for securing a dust-collecting bag on a dust-collecting machine, in which the dust-collecting bag has its opening portion wrapped therein with a tightening ring, and the wind-exhausting box has its wind-exhausting vent formed with a curve engage surface on the upper inner wall. Thus, the dust-collecting bag can be fixed on the curved engage surface of the wind-exhausting vent of the wind-exhausting box, simplifying structure, saving cost of machine parts and lowering probability of component damage.

### BRIEF DESCRIPTION OF DRAWINGS

This invention will be better understood by referring to the accompanying drawings, wherein:

FIG. 1 is a partial exploded perspective view of a conventional dust-collecting machine:

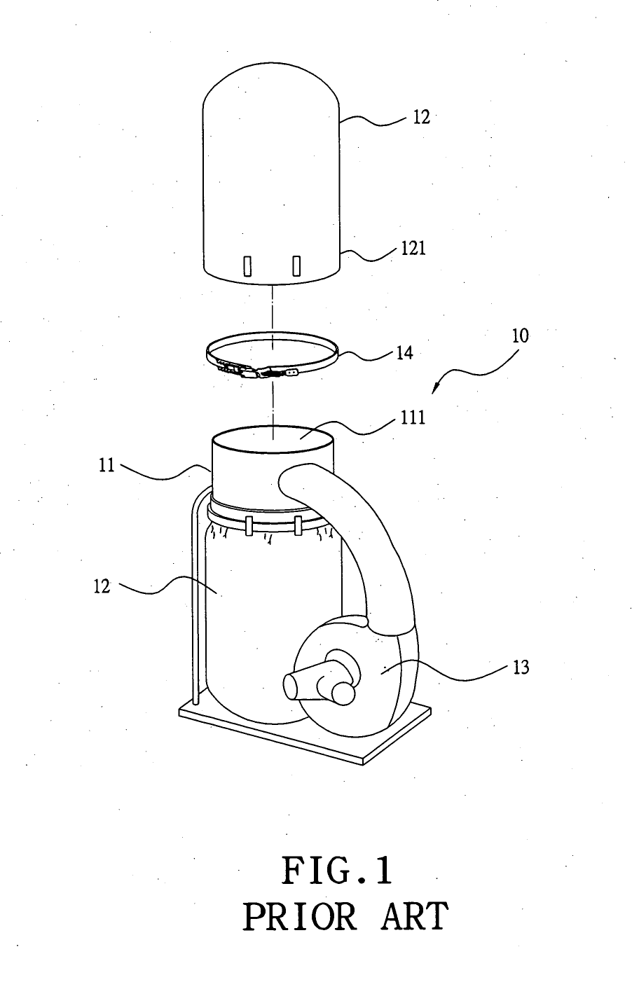

FIG. 2 is perspective view of the clasping strap of the conventional dust-collecting machine:

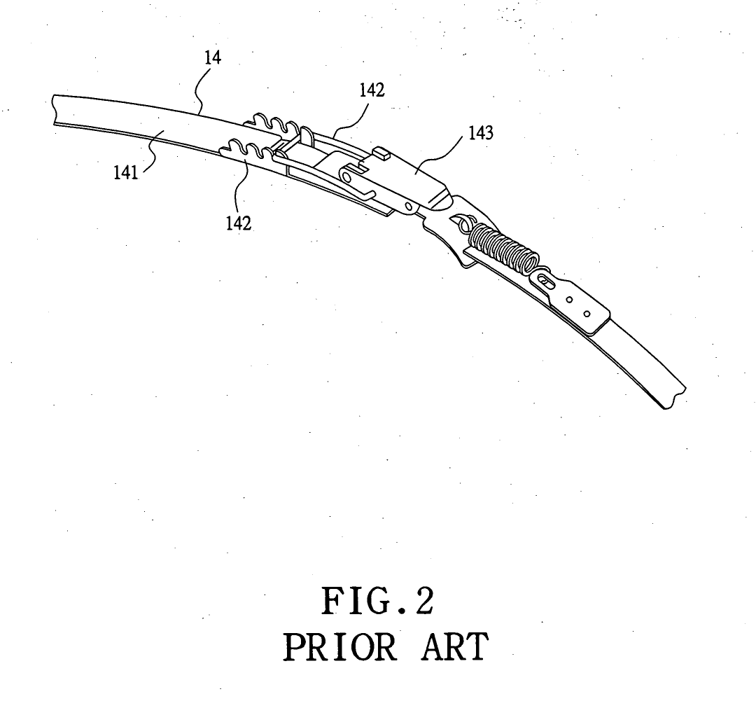

FIG. 3 is a perspective view of a dust-collecting machine in the present invention:

FIG. 4 is perspective view of the dust-collecting machine in the present invention, showing the dust-collecting bags separated from the wind-exhausting box:

FIG. 5 is a cross-sectional view of the dust-collecting machine in the present invention, showing the dust-collecting bag assembled on the wind-exhausting box:

FIG. 6 is a magnified cross-sectional view of the opening portion of the dust-collecting bag closely stuck on the engage surface of the wind-exhausting box in the present invention: and

FIG. 7 is a cross-sectional view of the dust-collecting machine in the present invention, showing the opening portion of the dust-collecting bag tightly stuck with the engage surface of the wind-exhausting box when the dust-collecting bag is pulled upward.

### DETAILED DESCRIPTION OF THE PREFERRED EMBODIMENT

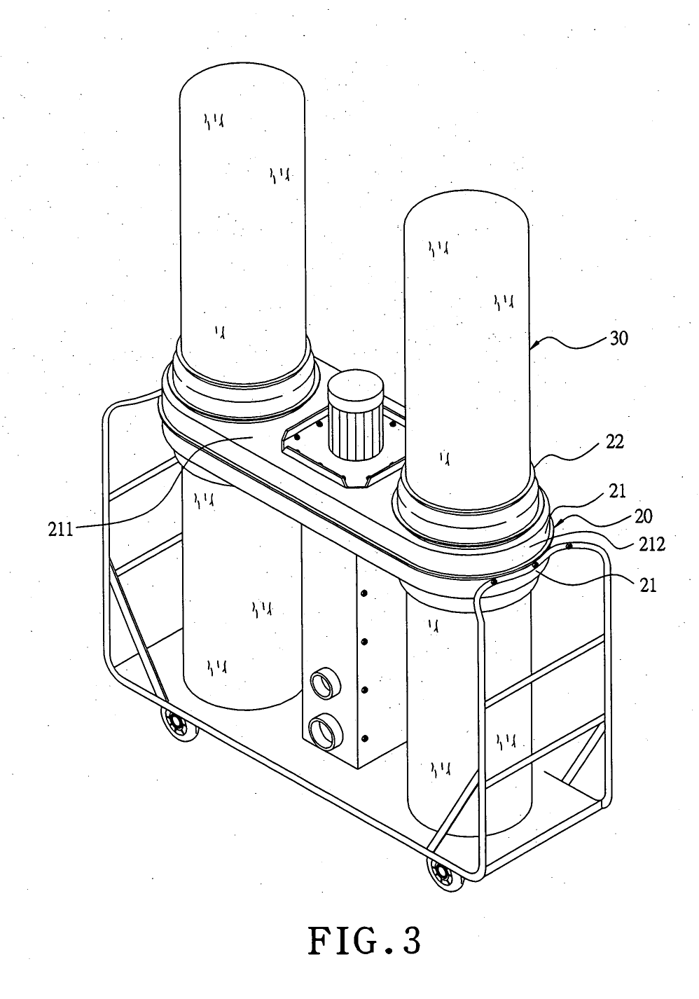

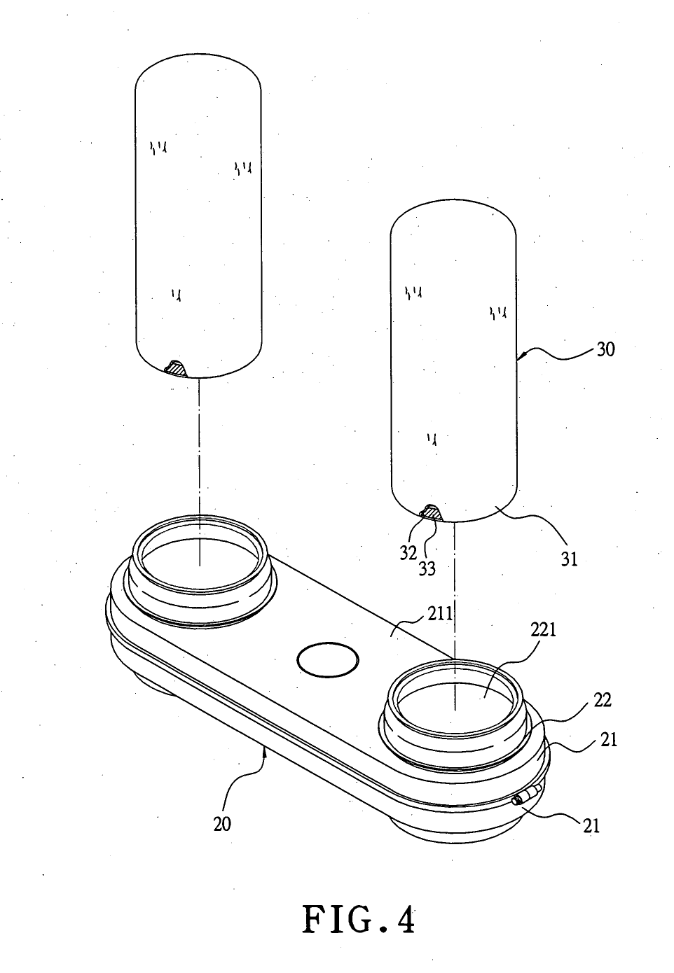

A preferred embodiment of a device for fixing a dust-collecting bag on a dust-collecting machine in the present invention, as shown in FIGS. 3 and 4, includes a wind-exhausting box 20 and two dust-collecting bags 30 combined together.

The wind-exhausting box 20 is provided with an upper and a lower cover 21 respectively having a horizontal base plate 211. The two horizontal base plates 211 have their circumferential edges respectively extending vertically to form a side wall 212 to be correspondingly combined: together and their opposite sides respectively bored with a through hole 213 having an annular fit base 22 provided thereon to form a wind-exhausting vent 221 for securing a dust-collecting bag 30 thereon.

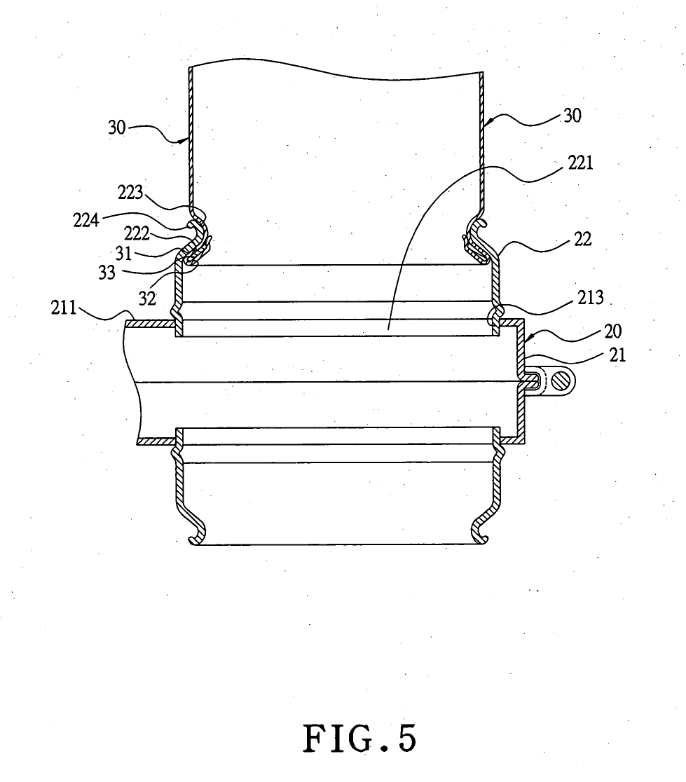

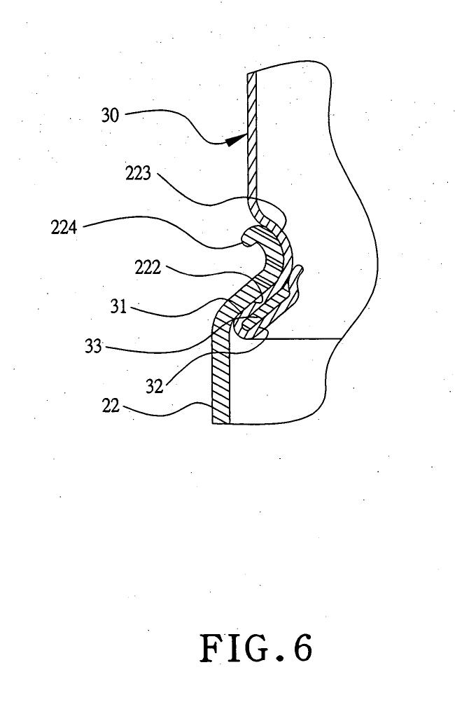

The annular fit base 22, as shown in FIGS. 5 and 6, has its upper inner wall near the wind-exhausting vent 221 formed with a curved engage surface 222 shrinking inward gradually and then extending outward to form a curved expanding surface 223, which is then bent outward to form an arc-shaped edge 224.

The dust-collecting bag 30 has a tightening ring 33 with a proper flexibility wrapped inside the bag body 32 of its opening portion 31.

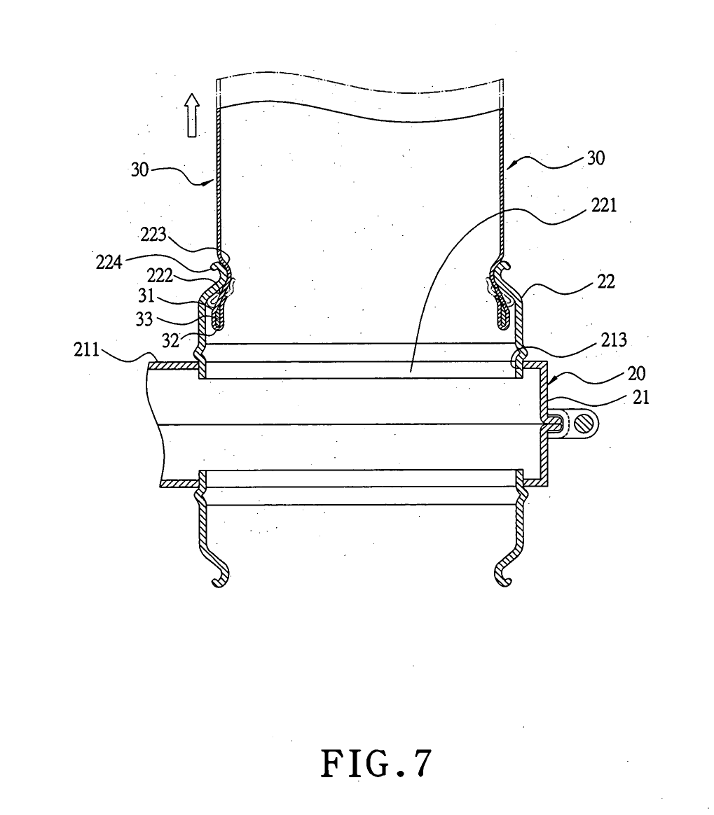

In assembling, as shown in FIG. 7, only press inward the opening portion 31 of the dust-collecting bag 30 to make the opening portion 31 and the tightening ring 33 slightly deformed to enable the opening portion 31 to be entirely deposited in the wind-exhausting vent 221 of the annular fit base 22 of the wind-exhausting box 20 and then release the opening portion 31 to let the bag body 32 and the tightening ring 33 inside recover their original shape. What should be noted is that the outer diameter of the opening portion 31 of the dust-collecting bag 30 is a little larger than the shortest diameter of the gradually shrinking engage surface 222 of the wind-exhausting vent 221; therefore when the dust-collecting bag 30 is entirely pulled outward and the tightening ring 33 recover its resilience, the opening portion 31 and the tightening ring 33 will be firmly stuck on the engage surface 222 in the wind-exhausting vent 221 to secure the dust-collecting bag 30 on the wind-exhausting box 20.

In this invention, the opening portion 31 of the dust-collecting bag 30 is designed in an engage-in mode. In other words, the opening portion 31 of the dust-collecting bag 30 is firmly engaged with the curved engage surface 222 of the wind-exhausting vent 221 of the wind-exhausting box 20 after it is received in the wind-exhausting vent 221. Therefore, when the dust-collecting bag 30 is expanded outward by a vacuum sucking force, the opening portion 31 of the dust-collecting bag 30 will be urged to push against the engage surface 222 comparatively tightly to ensure the dust-collecting bag 30 to be firmly secured on the exhausting box 22. To remove the dust-collecting bag 30 from the wind-exhausting box 22, only press inward the opening portion 31 of the dust-collecting bag 30 to make it deformed and then move it inward to disengage from the engage surface 222 in the wind-exhausting vent 221, quick and easy in assembling and disassembling of the dust-collecting bag 30.

While the preferred embodiment of the invention has been described above, it will be recognized and understood that various modifications may be made therein and the appended claims are intended to cover such modifications that may fall within the spirit and scope of the invention.

1. A device for fixing a dust-collecting bag on a dust-collecting machine comprising a wind-exhausting box, said wind-exhausting box provided thereon with at least one protruding-up annular fit base for exhausting wind, a dust-collecting bag fitted on said annular fit base: and characterized by
Said annular fit base has its upper inner wall formed with a curved engage surface gradually shrinking inward at a preset position: and
Said dust-collecting bag having its opening portion wrapped inside with a tightening ring with a proper flexibility, said opening portion of said dust-collecting bag received in the wind-exhausting vent of said wind-exhausting box after said opening portion and said tightening ring are pressed to become deformed, said dust-collecting bag pulled outward to let said opening portion firmly stuck on said engages surface of said wind-exhausting vent, said tightening ring inside said opening portion recovering its resilience and expanding outward, said tightening ring quickly and firmly stuck on said curved engage surface of said annular fit base, said opening portion of said dust-collecting bag able to disengage from said curved engage surface when said opening portion is pressed inward and moved upward, said dust-collecting bag being easy and quick in assembling with and disassembling from said annular fit base.

2. The device for fixing a dust-collecting bag on a dust-collecting machine as claimed in claim 1, wherein said wind-exhausting box comprises two covers respectively provided with a horizontal base plate having its circumferential edge extending vertically to form a side wall to be correspondingly combined together, said horizontal base plate of said cover bored with a through hole, said protruding-up annular fit base provided on said through hole to form a wind-exhausting vent, said curved engage surface formed at a preset location on the inner wall of said annular fit base.

3. The device for fixing a dust-collecting bag on a dust-collecting machine as claimed in claim 2, wherein said curved engage surface has its upper edge extending outward to form a curved expanding surface, which is then bent outward to form an arc-shaped edge.
